(19) United States
(12) Patent Application Publication
(10) Pub. No.: US 2007/0170223 A1
(43) Pub. Date: Jul. 26, 2007

(54) Nail Magazine for a Nailer

(76) Inventors: Rick Lin, Taichung City (TW); Jen Fang Jang, Taichung City (TW); Chu Chin Sung, Taichung City (TW)

Correspondence Address: BANGER SHIA, 204 CANYON CREEK, VICTORIA, TX, 77901, US

(21) Appl. No.: 11/625,313

(22) Filed: Jan. 20, 2007

(30) Foreign Application Priority Data
Jan. 24, 2006 (TW) 95102638

(51) Int. Cl. B25C 5/00

(52) U.S. Cl. 227/137; 227/120

(57) ABSTRACT

A nail magazine for a nailer comprises a base, a cover pivotally and elastically connected to the base, and a receiving disc. Once the cover is pulled outward, it can be pushed a certain angle away from the base automatically. On a side of the cover are formed an ear and a rotary shaft. The receiving disc is correspondingly provided with a rotary member. By disengaging the cover from the base and moving it to an angle and then keeping moving it, the receiving disc can be moved out of the base completely, for easy nail loading. Therefore, the operation is simple, quick and can be done with one hand.

### BACKGROUND OF THE INVENTION

1. Field of the Invention

The present invention relates to a nailer for driving nails continuously, and more particularly to a nail magazine for a nailer, which is simply structured and easy to operate.

2. Description of the Prior Art

Nailer is a power tool widely used in various fields, such as: decoration, construction, packaging fields. In order to drive nails continuously, the nailer is usually provided with a winding type magazine which is located between the body and the handle of the nailer. The magazine is opened through rotation of the cover, and nails are loaded on a receiving disc of the magazine.

It is to be noted that, to prevent the cover of the magazine from stopping the top portion of the receiving disc and causing interference when loading nails onto the receiving disc, a receiving disc for a nailer disclosed in U.S. Pat. No. 6,957,757 is provided with a pivotal device that can enable the receiving disc to be rotated a certain angle during the nail loading process, thus the nails can be loaded into the magazine easily.

Though the problem of the magazine's cover-caused interference with the nail-loading operation is solved, the receiving disc must be turned to an inclined position prior to loading nails, and after loading, the receiving disc has to be rotated to its original position to close the magazine, therefore, this type of magazine is inconvenient to use. Further, the pivotal device is complicated in structure, so it is not easy to assemble and its cost is relatively high.

Accordingly, another conventional structure was developed, as shown in FIG. 1, wherein the magazine base 10, the receiving disc 11 and the cover 12 are coaxially and rotatably arranged, so that the receiving disc 11 can be moved out of the magazine base 10 and the receiving disc 11 completely. Therefore, the nails can be loaded easily and the structure is very simple.

However, the problem of the abovementioned structure is that the receiving disc cannot be positioned appropriately, and consequently the receiving disc usually rotates left and right when the magazine is opened. When loading nails, the user has to rotate the receiving disc 11 out of the magazine and hold firm with one hand to maintain it at a proper position, obviously, this magazine is simple in structure but is not convenient enough to use.

The present invention has arisen to mitigate and/or obviate the afore-described disadvantages.

### SUMMARY OF THE INVENTION

The primary objective of the present invention is to provide a nail magazine for a nailer, which comprises a base, a cover and a receiving disc. By opening the cover to an angle with only one hand, the receiving disc can be moved out of the base and get positioned, thus facilitating the nails loading operation and providing an easy one-hand operation.

Another objective of the present invention is to provide a nail magazine for a nailer, which comprises a base, a cover pivotally and elastically connected to the base, and a receiving disc. Since the structure of the present invention is simple, the resultant product cost can be reduced substantially.

To obtain the abovementioned objectives, a nail magazine for a nailer in accordance with the present invention comprises:

a base with a semi-circular covering portion and a disc-shaped base portion, on the outer periphery of the base portion being formed protruding ears;

a cover with an ear and a rotary shaft to be engaged with the covering portion of the base to form a circular magazine, the ear of the cover is elastically and pivotally connected to the protruding ears of the base such that once the cover is pulled outward, it can be pushed away from the base automatically, the rotary shaft, extending from the bottom of the ear along an axial direction thereof, is staggered from the through hole, a pushing portion is formed on the outer surface of the rotary shaft;

a receiving disc disposed on the base, a shaft disposed at the center of the receiving disc, a shaft a rotary member disposed on a side of the receiving disc, the rotary member is C-shaped in cross section, and its open end opens toward the receiving disc and is aligned to the position of the cover and the base, on a surface of the rotary member being formed an abutting portion to be pushed by the pushing portion of the cover, when the cover is disengaged from the base and opened to an angle, the pushing portion will push the abutting portion to move the receiving disc, and thus the receiving disc will be moved out of the base and get positioned.

With the abovementioned arrangements, the present invention can obtain the following functions and effects:

1, unlike the conventional structure that must be provided with the complicated slant pivot device, the nail magazine of the present invention is simply structured and is opened in a two-step manner. By disengaging the cover from the base and moving it to an angle and then keeping moving it, the receiving disc can be moved out of the base completely, for easy nail loading. Therefore, the operation is simple, quick and can be done with one hand.

2. when the cover is opened to the maximum position, the body, the cover, and the receiving disc are ensured to be positioned at intervals and angle difference, so that the receiving disc is positioned firmly for facilitating the nail loading operation.

### BRIEF DESCRIPTION OF THE DRAWINGS

FIG. 1 is a perspective view of a conventional nail magazine;

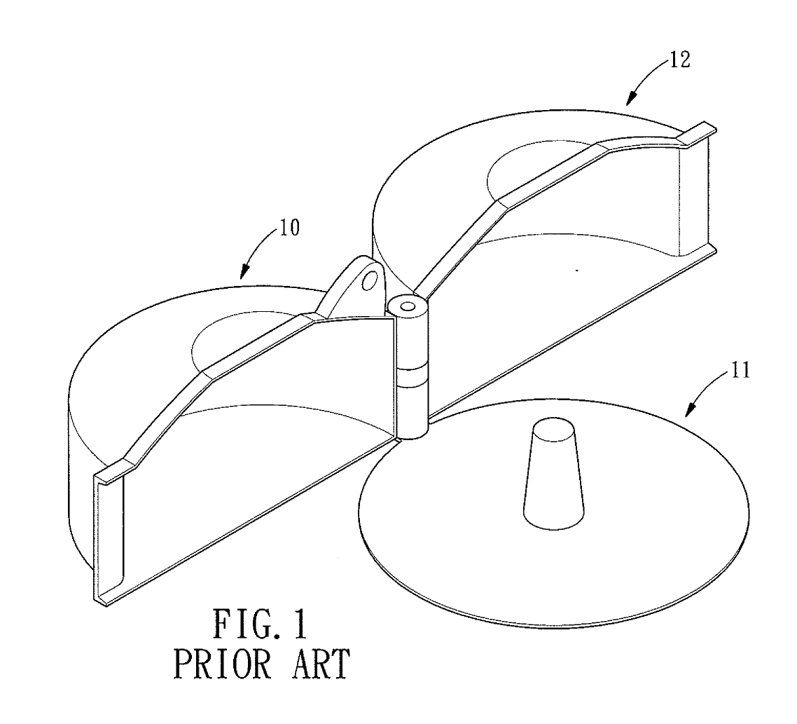

FIG. 2 is a perspective view of showing the open state of a nail magazine in accordance with the present invention;

FIG. 3 is an exploded view of the nail magazine in accordance with the present invention;

FIG. 4 is an enlarged perspective view of a rotary shaft of the cover and a rotary member of the receiving disc of the nail magazine in accordance with the present invention;

FIG. 5 is a top cross sectional view of the nail magazine in accordance with the present invention;

FIG. 6 is an enlarged view of a part of FIG. 5 of showing the rotary shaft of the cover;

FIG. 7 is a top cross sectional view in accordance with the present invention of showing the initial state of opening the cover;

FIG. 8 is an enlarged view of a part of FIG. 7 of showing the rotary shaft of the cover;

FIG. 9 is a top cross sectional view in accordance with the present invention of showing that the receiving disc has been moved out of the base of the magazine; and

FIG. 10 is an enlarged view of a part of FIG. 9 of showing the rotary shaft of the cover.

### DETAILED DESCRIPTION OF THE PREFERRED EMBODIMENT

The present invention will be more clear from the following description when viewed together with the accompanying drawings, which show, for purpose of illustrations only, the preferred embodiment in accordance with the present invention.

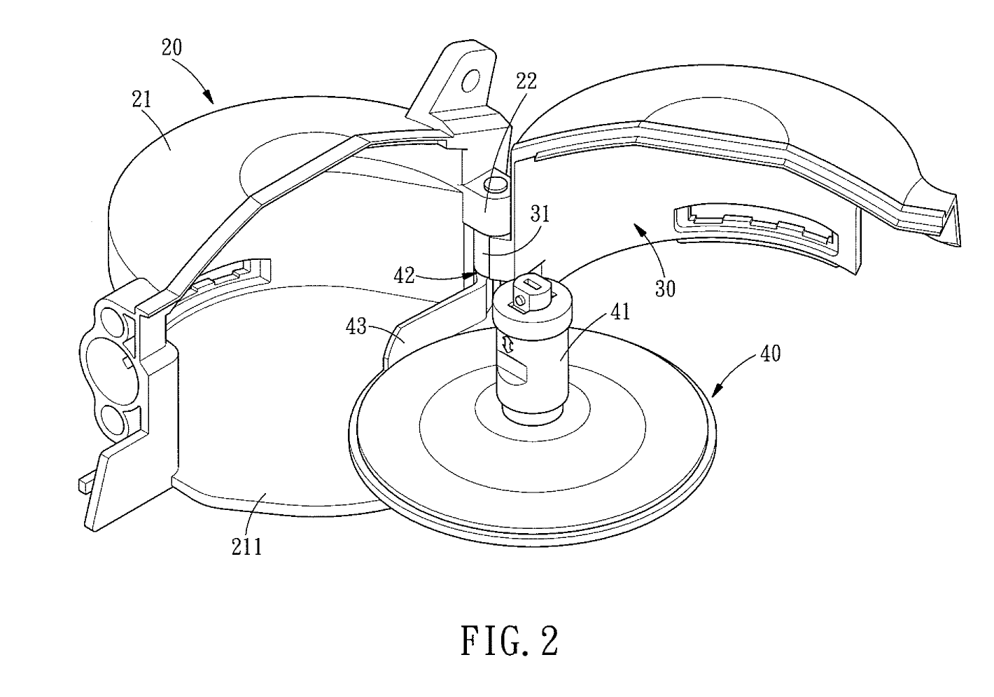

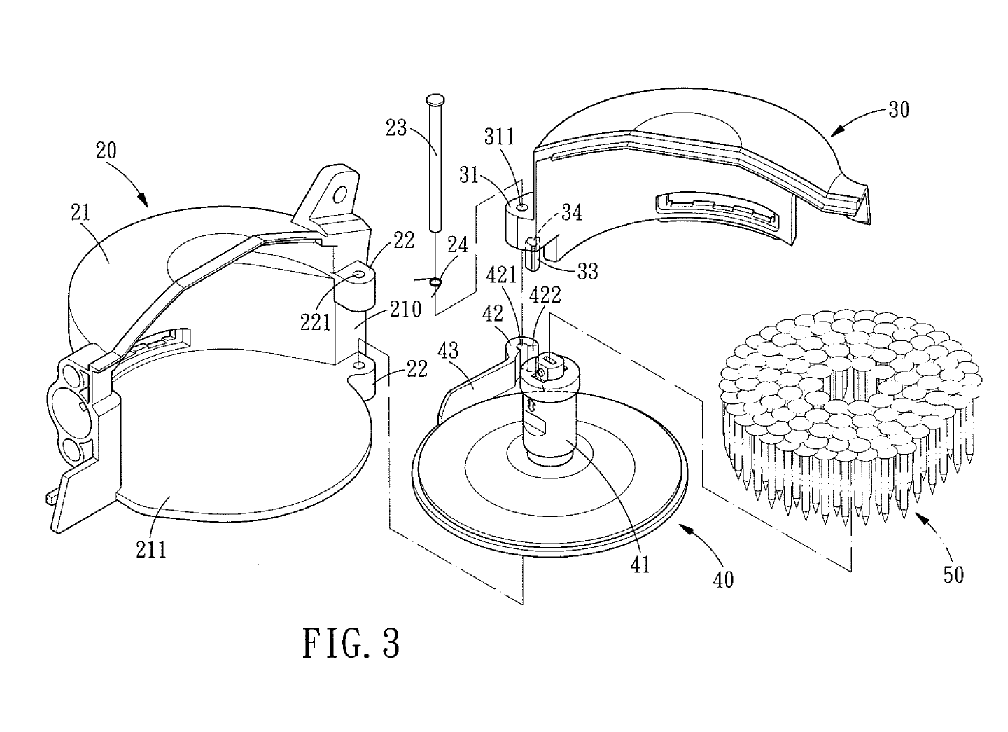

Referring to FIGS. 2 and 3, a nail magazine for a nailer in accordance with the present invention comprises: a base 20, a cover 30 pivotally connected to the base 20, and a receiving disc 40 pivotally connected to the magazine 30. By disengaging the cover 30 from the base 20 and moving it to an angle and then keeping moving it, the receiving disc 40 can be moved out of the base 20, namely, the receiving disc 40 can be moved out of the base 20 along with the magazine opening operation, for facilitating nail loading.

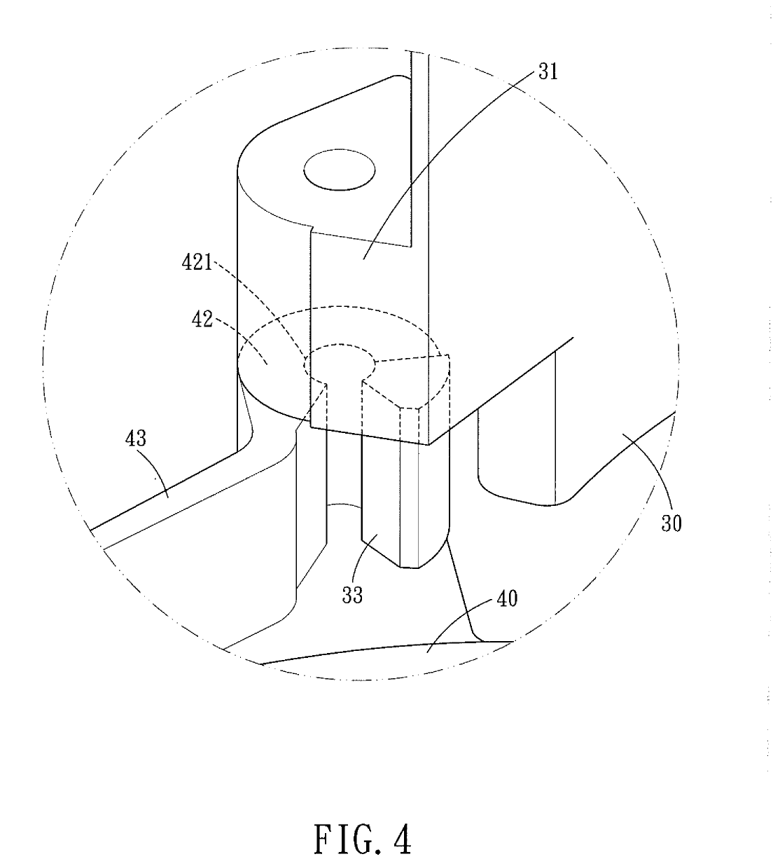

Referring to FIGS. 2, 3 and 4, the base 20 includes a semi-circular covering portion 21, at the bottom of the covering portion 21 is formed a disc-shaped base portion 211, and half of the base portion 211 is exposed out of the covering portion 21. A straight and flat outer sidewall 210 is formed on a side of the base portion 21, on the outer sidewall 210 and on the outer periphery of the base portion 211 is formed a protruding ear 22, respectively, and the ears 22 are arranged at an interval. Each of the ears 22 is formed with an aligned pivot hole 221 for installation of a pivot 23 mounted with an elastic member 24.

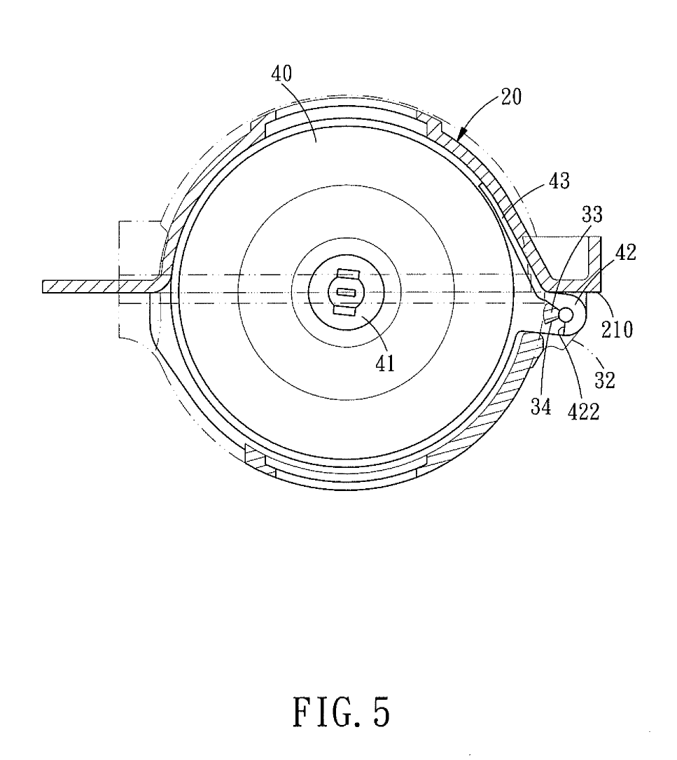

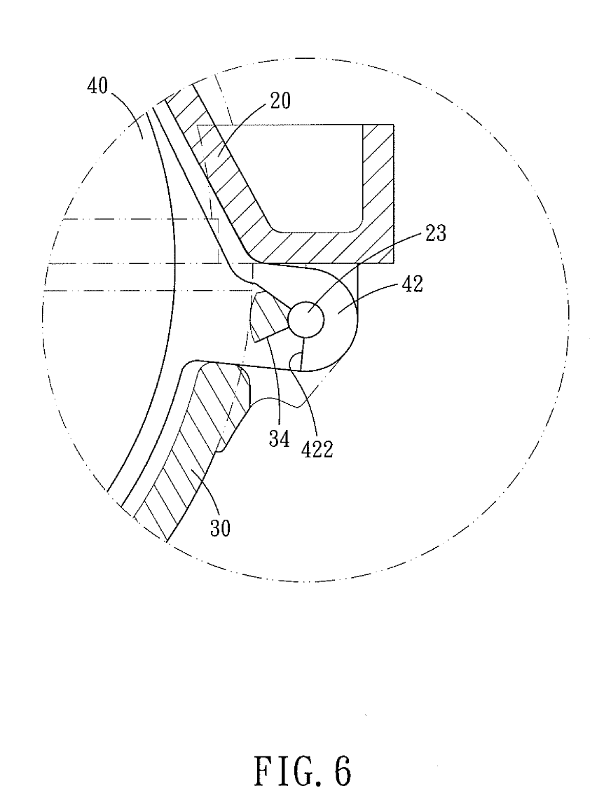

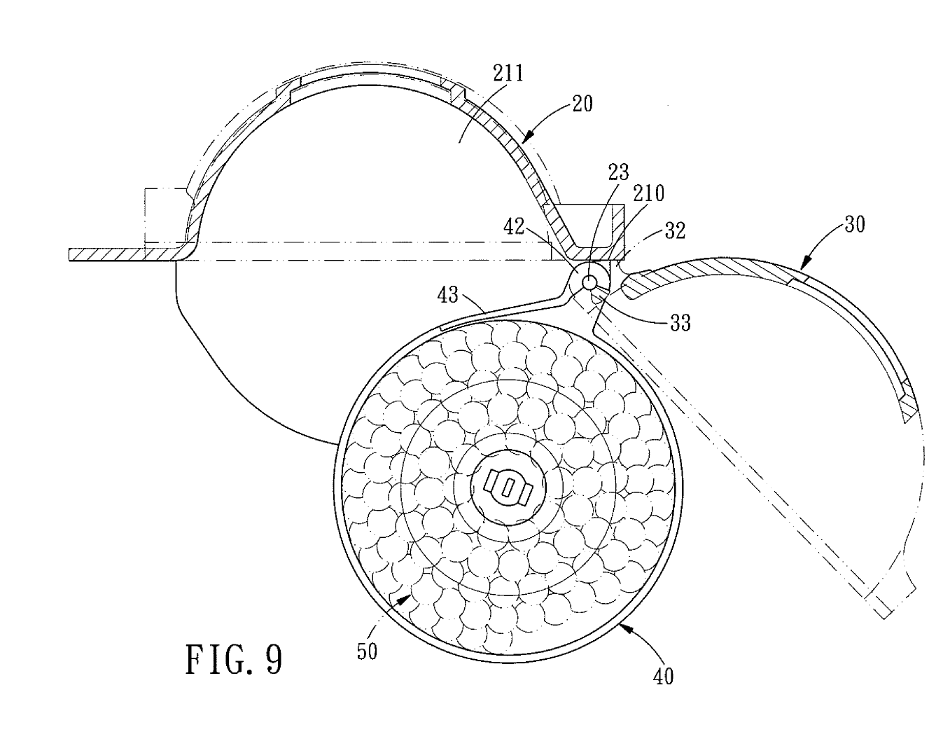

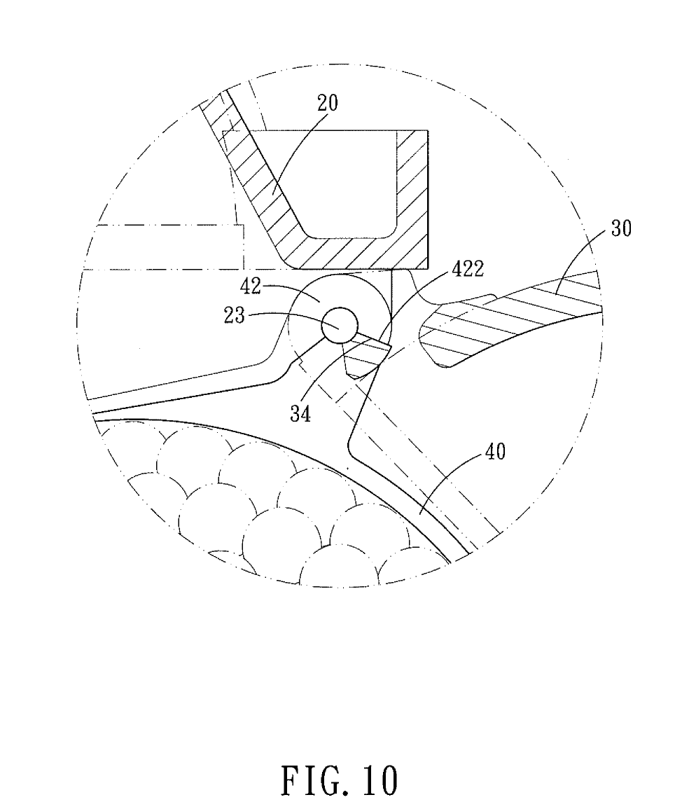

The cover 30 is a reverse-L shaped structure to be engaged with the covering portion 21 of the base 20 to form a circular magazine. On a side of the cover 30 are formed an ear 31 with a through hole 311 and a rotary shaft 33, and at the outer surface of the ear 31 is formed an outer stopping portion 32, as shown in FIGS. 5 and 6, which is to be positioned against the outer sidewall 210 of the base 20 after the cover 30 is opened to its maximum position, thus providing an positioning effect (serving as a cover opening and closing positioning structure), as shown in FIGS. 9 and 10. The rotary shaft 33, extending from the bottom of the ear 31 along an axial direction thereof, is staggered from the through hole 311 and is fan-shaped in cross section. A pushing portion 34 is formed on the outer surface of the rotary shaft 33.

The receiving disc 40 is disposed on the base portion 211, at the center of the receiving disc 40 is formed a shaft 41 around which the nails are wound, a rotary member 42 is located beside the shaft 41, and an extending piece 43 is integral with and extends from the rotary member 42 such that the rotary member 42 is C-shaped in cross section and its open end opens toward the receiving disc 40. In the open end of the rotary member 42 is defined a groove 421 for accommodation of the pivot 23, and on the outer surface of the groove 421 is formed an abutting portion 422 to be pushed by the pushing portion 34 of the rotary shaft 33.

The rotary shaft 33 of the cover 30 is inserted in the groove 421, and then the cover 30 and the rotary member 42 are placed between the two ears 22 of the base 20. After that, the pivot 23 mounted with the elastic member 24 is inserted through the pivot holes 221, the through hole 311 and into the groove 421, and the elastic member 24 is biased between the cover 30 and the base 20, so that once the cover 30 is opened, automatically, the elastic member 24 will push the cover 30 away from the base 20. With reference to FIGS. 9 and 10, after the nails 50 are loaded in the receiving disc 40, the receiving disc 40 can rotate around the pivot 23 to move into the cover 21, and then is positioned on the base portion 211. Along with that, the edge of the cover 30 is engaged against the covering portion 21 to cover the nails 50. A gap is defined in a side surface of the cover 30 for passage of the nails 50 during nailing process, the pushing portion 34 is located away from the abutting portion 422, and the rotary shaft 33 is abutted against the surface of the extending piece 43.

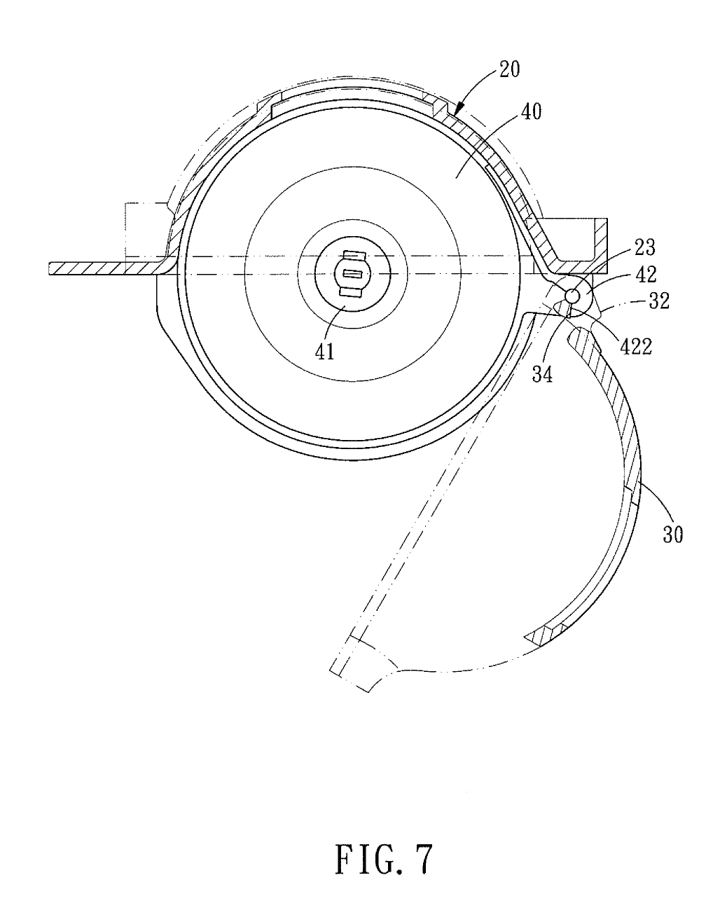

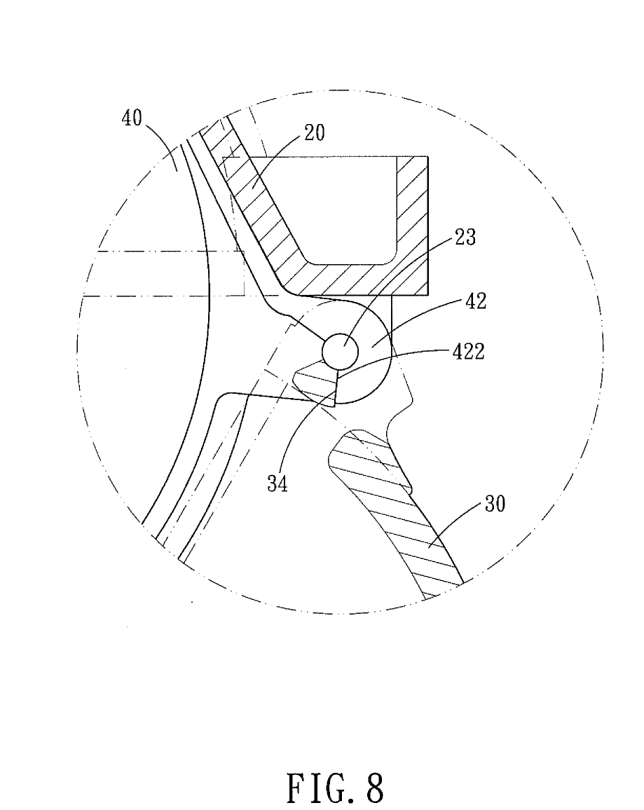

The convenience of loading the nails 50 is particularly obvious, as shown in FIGS. 5-10, when loading nails, the user can open the cover 30 with only one hand, and then the cover 30 is pushed slightly away from the base 20 by the elastic member 24. Since the receiving disc 40 has not been pushed, the abutting portion 422 will stop the pushing portion 34 to prevent further opening action of the cover 30, as shown in FIGS. 7 and 8. And then, as shown in FIGS. 9 and 10, since the pushing portion 34 is in contact with the abutting portion 422, at this moment, if the user keeps pushing the cover 30 to make it rotate away from the base 20, the pushing portion 34 will push the abutting portion 422 to make the receiving disc 40 move away from the base 211 by rotating around the pivot 23 until the outer sidewall 210 is stopped by the outer stopping portion 32 (reaching the maximum opening position). At this moment, the receiving disc 40 is completely moved out of the base 20 and the cover 30, and is positioned therebetween for allowing the user to load nails 50 onto the receiving disc 40.

It is to be noted that when pushing the receiving disc 40, the pushing portion 34 contacts the abutting portion 422 and is located away from the extending piece 43. Therefore, there will be an angle different between the base 20, the cover 30 and the receiving disc 40, after the receiving disc 40 is opened to the maximum position. And the cover 30 doesn't interfere with the position of the receiving disc 40, so that the nails 50 can be loaded easily. After the nail loading action is finished, the user can push the cover 30 in a reverse direction, making it drive the receiving disc 40 to the base portion 211.

By such arrangements, with only one hand, the receiving disc 40 can be moved out of the base 20 and get positioned, thus facilitating the nails 50 loading operation. Opening the cover 30 can pull out the receiving disc 40, it is very convenient and can reduce the number of times of hand operation. In addition, the structure of the present invention is simple and the resultant cost is relatively low.

While we have shown and described various embodiments in accordance with the present invention, it is clear to those skilled in the art that further embodiments may be made without departing from the scope of the present invention.

What is claimed is:

1. A nail magazine for a nailer comprising:
a base with a base portion, on an outer periphery of the base portion being formed protruding ears;
a cover with an ear pivotally connected to the protruding ears of the base, a rotary shaft disposed on a side of the ear, a pushing portion formed on a surface of the rotary shaft;
a receiving disc disposed on the base, a rotary member disposed on a side of the receiving disc, the receiving disc being pivotally coupled to the ear of the cover through the rotary member, on a surface of the rotary member being formed an abutting portion to be pushed by the pushing portion of the cover, when the cover is disengaged from the base and opened to an angle, the pushing portion will push the abutting portion to move the receiving disc, and thus the receiving disc will be moved out of the base and get positioned.

2. The nail magazine for a nailer as claimed in claim 1, wherein the base includes a semi-circular covering portion, at a bottom of the covering portion is formed a disc-shaped base portion, and half of the base portion is exposed out of the covering portion, a straight and flat outer sidewall is formed on a side of the base portion, on the outer sidewall and on an outer periphery of the base portion is formed a protruding ear, respectively, and the protruding ears are arranged at an interval, each of the ears is formed with an aligned pivot hole for installation of a pivot mounted with an elastic member.

3. The nail magazine for a nailer as claimed in claim 2, wherein the cover is a reverse-L shaped structure to be engaged with the covering portion of the base to form a circular magazine, the ear of the cover is formed with a through hole for insertion of the pivot.

4. The nail magazine for a nailer as claimed in claim 1, wherein an outer stopping portion is formed at an outer surface of the ear of the cover and is to be positioned against the outer sidewall of the base after the cover is opened to its maximum position.

5. The nail magazine for a nailer as claimed in claim 3, wherein an outer stopping portion is formed at an outer surface of the ear of the cover and is to be positioned against the outer sidewall of the base after the cover is opened to its maximum position.

6. The nail magazine for a nailer as claimed in claim 1, wherein the rotary shaft is fan-shaped in cross section.

7. The nail magazine for a nailer as claimed in claim 2, wherein an extending piece is integral with and extends from the rotary member such that the rotary member is C-shaped in cross section, and in open end of the rotary member is defined a groove for accommodation of the pivot.
